(19) United States
(12) Patent Application Publication
(10) Pub. No.: US 2005/0263516 A1
(43) Pub. Date: Dec. 1, 2005

(54) Heating device

(75) Inventors: Masuhiro Natsuhara, Itami-shi (JP); Hirohiko Nakata, Itami-shi (JP); Akira Kuibira, Itami-shi (JP); Kenji Shinma, Itami-shi (JP)

Correspondence Address: DARBY & DARBY P.C., P. O. BOX 5257, NEW YORK, NY, 10150-5257, US

(73) Assignee: Sumitomo Electric Industries, Ltd., Osaka-shi (JP)

(21) Appl. No.: 11/140,668

(22) Filed: May 27, 2005

(30) Foreign Application Priority Data
May 28, 2004 (JP) 2004-158678

(51) Int. Cl. F27D 11/00

(52) U.S. Cl. 219/385

(57) ABSTRACT

The present invention provides a heating device which is rigid with little likelihood of warping. The workpiece mounting surface has a high thermal conductivity, and there is improved heat uniformity, and rapid cooling is possible. The heating device of the present invention comprises: a mounting part for mounting the workpiece; a heating part which has a resistance heating element and which heats the mounting part; and a support part which supports the mounting part and heating part. The Young's modulus for each of the mounting part and support part is 100 GPa or greater. By having a Young's modulus of 100 GPa or greater, even if the mounting part is thin, there is little deformation when pressed by a probe card.

### BACKGROUND OF THE INVENTION

1. Field of the Invention

The present invention relates to a heating device used in semiconductor manufacturing devices and semiconductor testing devices. In addition, the present invention relates to wafer probers, handlers, and testers and the like on which this heating device is mounted.

2. Description of the Background Art

In the prior art, heat treatment of a semiconductor substrate (wafer) as a workpiece is conducted in a testing step for a semiconductor. In other words, the wafer is heated to a higher temperature than the usual usage temperature, and any semiconductor chips which have the possibility of failing are made to fail at an accelerated rate and are removed. This is a burn-in test in order to prevent the occurrence of failure after shipping. In the burn-in step, after forming a semiconductor circuit on the semiconductor wafer and prior to cutting the individual chips, the electrical performance of each chip is measured while the wafer is being heated. Any defective products are removed. With this burn-in step, there is a strong desire to shorten the processing time in order to improve the through-put.

With this burn-in step, a heater is used to hold the semiconductor substrate and to heat the semiconductor substrate. With the heaters of the prior art, the entire undersurface of the wafer must be in contact with the ground electrode. As a result, metallic heaters are used. The wafer on which a circuit is formed is placed on top of a flat, metallic heater, and the electrical properties of the chip are measured. During the measurement, a measurement device called a probe card which has a plurality of electrode pins for forming an electrical connection is pressed against the wafer at a force of several 10's of kgf to several hundred kgf. If the heater is thin, the heater can become deformed, and there may be contact failure between the wafer and the ground electrode. As a result, in order to have a rigid heater, a metal plate with a thickness of at least 15 mm must be used. Raising and lowering the temperature of the heater requires a long time, and this is a major obstacle in improving throughput.

In addition, with the burn-in step, the electrical properties are measured by running electricity through the chip. However, in recent years, chips have increased in their outputs, and these chips generate a large amount of heat during this measurement of electrical properties. In some situations, the chip is destroyed by its own heat. As a result, after measurement, the chip must be cooled rapidly. In addition, during measurement, a uniform heat is desired. Therefore, copper (Cu) which has a high thermal conductivity of 403 W/mK is used for the metal material.

In Japanese Laid Open Patent Publication Number 2001-033484, a wafer prober is proposed in which, instead of a thick metal plate, a thin metal layer is formed on the surface of a ceramic substrate. Even though it is thin, it has a high rigidity and does not deform easily. This wafer prober does not readily deform and has a small heat capacity. According to Japanese Laid Open Patent Publication Number 2001-033484, because of the high rigidity, contact failure does not occur, and because the heat capacity is small, the temperature is raised and lowered in a short time. Aluminum alloy or stainless steel and the like are used as a support stand for installing the wafer prober.

However, as described in Japanese Laid Open Patent Publication Number 2001-033484, when the wafer prober is supported only at its outermost perimeter, the wafer prober can become warped by the pressure from the probe card. As a result, a plurality of support braces and the like must be provided.

In addition, ceramics with high thermal conductivity include AIN and SiC. However, their thermal conductivities are normally in the range of 150-180 W/mK. When compared with pure Cu which has a thermal conductivity of 403 W/mK, the thermal conductivity of ceramics is low. As a result, this goes against the objective of improving heat uniformity and having rapid cooling. With a ceramic substrate, the performance for these may be poor.

### SUMMARY OF THE INVENTION

The object of the present invention is to solve the above problems. In other words, the object of the present invention is to provide a heating device having the following: a high rigidity so that there is no danger of warping even without providing a plurality of braces; a high thermal conductivity on its workpiece mounting surface; improved heat uniformity; and ability to rapidly cool a chip.

The present invention is a heating device, comprising: a mounting part for mounting a workpiece; a heating part for heating the mounting part and which has a resistance heating element; a support part which supports the mounting part and the heating part. The Young's modulus for the mounting part and the support part are each 100 GPa or greater. By having the Young's modulus 100 GPa or greater, even when the mounting part is thin, there is little deformation when the probe card is pressed against the heating device. In addition, even when the mounting is supported only at its outermost perimeter, there is little deformation of the mounting part. Preferably, the Young's modulus for the mounting part and the support part are each 200 GPa or greater. More preferably, the Young's modulus for the mounting part and the support part are each 300 GPa or greater.

The thermal conductivity of the mounting part is preferably 50 W/mK or greater. The material for the mounting part is preferably selected from a group consisting of Al—SiC, Si—SiC, SiC, AlN, and Si₃N₄.

The heating part is preferably a ceramic in which a resistance heating element is formed on the inside or on the surface. Alternatively, the heating part is a resistance heating element formed on the opposite side as a workpiece mounting surface of the mounting part. In addition, the heating part may be constructed as a heating element interposed between insulating elements. In this situation, the insulating element is preferably a resin. More preferably, a filler is dispersed in the resin. In addition, the insulating element is preferably mica.

The resistance heating element is preferably stainless steel or nichrome.

In addition, the support part preferably has a thermal conductivity of 50 W/mK or less.

The material for the support part is preferably selected from the group consisting of alumina, mullite, composite of mullite and alumina, cordierite, steatite, and forsterite.

Furthermore, the heating device is preferably equipped with a cooling module which can contact or separate from the heating part. In addition, a conductive layer is preferably formed on the workpiece mounting surface side of the mounting part. The main component of the conductive layer is preferably Ni.

The heating device is preferably used in a device for heating and testing a wafer.

According to the present invention, the heating device comprises a mounting part for mounting a workpiece, a heating part with a resistance heating element for heating the mounting part, and a support part for supporting the mounting part and heating part. When the Young's modulus for the mounting part and support part is 100 GPa or greater, an excellent heating device which does not deform is provided.

### BRIEF DESCRIPTION OF THE DRAWINGS

FIG. 1 is one example of the cross-sectional construction of a semiconductor heating device of the present invention.

FIG. 2 is another example of the cross-sectional construction of a semiconductor heating device of the present invention.

FIG. 3 is a another example of the cross-sectional construction of a semiconductor heating device of the present invention.

### DETAILED DESCRIPTION OF THE INVENTION

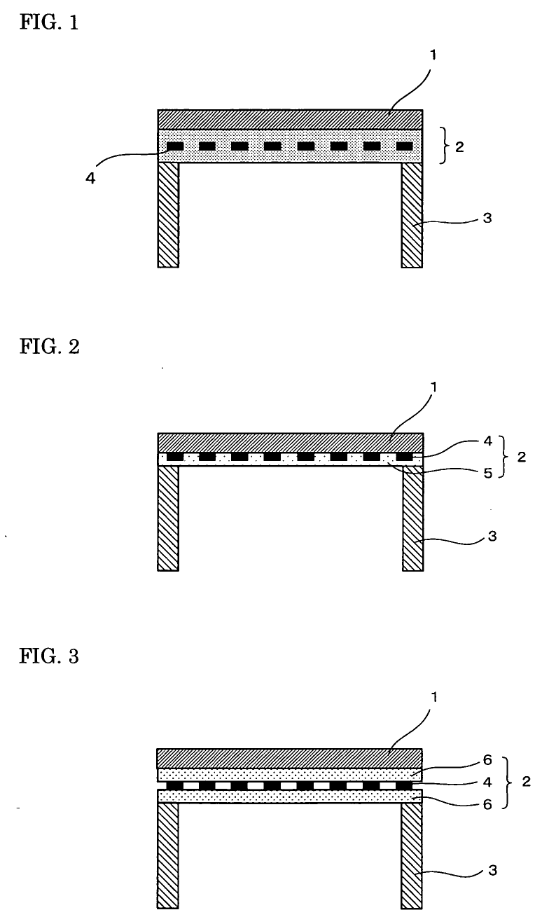

Referring to FIG. 1, an implementation mode of the present invention is described. FIG. 1 is one example of an implementation mode of the present invention. The heating device of the present invention comprises a mounting part 1 for mounting a workpiece, a heating part 2 with a resistance heating element 4 for heating mounting part 1, and a support part 3 which supports the mounting part and the heating part. The Young's modulus for each of mounting part 1 and support part 3 is 100 GPa or greater. If the Young's modulus is less than 100 GPa, when a wafer is mounted onto the mounting part and heated and tested, the mounting part becomes deformed if the probe card is pushed at a high pressure. The Young's modulus for the mounting part and support part is preferably 200 GPa or greater. Furthermore, if it is 300 GPa or greater, the mounting part can be thin, and the heat capacity of the mounting part is small, and this is preferred.

The mounting part has the role of transmitting the heat generated in the heating part to the workpiece, such as a wafer or the like. In addition, the temperature uniformity of the workpiece mounting surface of the mounting part is preferably uniform. Therefore, the thermal conductivity of the mounting part is preferably 50W/mK or greater. If the thermal conductivity is less than 50W/mK, the heat uniformity of the workpiece mounting surface is poor.

The material for the mounting part is preferably selected from Al—SiC, Si—SiC, SiC, AlN, Si₃N₄. These materials have Young's moduli and thermal conductivities shown in Table 1. Among these, Si—SiC is the best.

TABLE 1

| | Young's modulus | Thermal conductivity |
|---|---|---|
| Material | (GPa) | (W/mK) |
| Al—SiC | 265 | 170 |
| Si—SiC | 370 | 220 |
| SiC | 420 | 60 |
| AlN | 330 | 170 |
| Si₃N₄ | 290 | 50 |

The heating part preferably has a resistance heating element formed on the interior or on the surface of a ceramic. For the ceramic, examples include alumina, silicon nitride, aluminum nitride, aluminum oxynitride, silicon carbide, and the like. The heating part is a ceramic heater in which a resistance heating element is formed on the surface or in the inside of this ceramic. Because the heating part must rapidly raise and lower temperatures depending on the situation, a material with a high thermal shock resistance is suitable. As the ceramic with a high thermal shock resistance, silicon nitride, aluminum nitride, aluminum oxynitride, and silicon carbide are preferred. From the standpoint of having the heat uniformly distributed, aluminum nitride is preferred.

In addition, as shown in FIG. 2, heating part 2 can also have resistance heating element 4 formed on the surface on the opposite side as the workpiece mounting surface of mounting part 1. In this situation, in order to protect the resistance heating element and to ensure electrical insulation, there is preferably a protective layer 5 of an insulating element such as glass or the like. In addition, when the mounting part is an electrical conductor, an insulating element can be inserted between the mounting part and the resistance heating element. The insulating element is formed by flame spray coating or screen printing or the like an insulating substance such as alumina or glass or the like onto at least the areas where the mounting part contacts the resistance heating element. When coating by screen printing, a powder of the insulating substance is made into a paste by adding binders and organic solvents. The paste is then coated onto the part of the mounting part which contacts the resistance heating element or onto the part of the resistance heating element which contacts the mounting part. After degreasing as needed, the insulation element (insulation layer) is formed by firing.

In addition, the insulation element can be a resin. If it is a resin, in the same manner as with the screen printing, the resin is coated at least onto the part of the mounting part which contacts the resistance heating element or onto the part of the resistance heating element which contacts the mounting part. Heat treatment is conducted as needed to make the insulating element. For the resin, various resins such as silicon resin, phenol resin, epoxy resin, fluororesin, and the like can be used. These can be selected according to the usage temperature. In addition, when a filler such as glass or the like is dispersed in the resin, the thermal conductivity of the insulating element is improved and thus this is preferable. When the thermal conductivity of the insulating element is improved, the temperature of the resistance heating element is rapidly transmitted to the mounting part. As a result, the heating device has excellent responsiveness.

In addition, as shown in FIG. 3, heating part 2 can be constructed by interposing resistance heating element 4 between insulating elements 6. In this situation, the insulating element is preferably a resin. In the same manner as with the screen printing described above, the resin is coated onto the part of the mounting part which contacts the resistance heating element or onto the part of the resistance heating element which contacts the mounting part. Heat treatment is conducted as needed to make the insulating element. For the resin, various resins such as silicon resin, phenol resin, epoxy resin, fluororesin, and the like can be used. These can be selected according to the usage temperature. In addition, when a filler such as glass or the like is dispersed in the resin, the thermal conductivity of the insulating element is improved, and thus this is preferred. When the thermal conductivity of the insulating element is improved, the temperature of the resistance heating element is rapidly transmitted to the mounting part. As a result, the heating device has excellent responsiveness.

In addition, mica can be used as insulating element 6. Mica is preferred because it has excellent insulation properties and excellent heat resistance, as well as being relatively inexpensive. For example, a stainless steel resistance heating element can be interposed between two sheets of mica. This is affixed to the mounting part by screws or the like to make the heating part.

Metal materials are used for the resistance heating element. For example, metal foil of nickel, stainless steel, tungsten, molybdenum, chromium, and their metal alloys can be used. Of these metals, stainless steel and nichrome are preferred. When making into a shape of a heating element, stainless steel and nichrome form a resistance heating element circuit pattern with a relatively high precision by a method such as etching and the like. In addition, they are inexpensive and have oxidation resistance. As a result, they can be used over a long period even at high usage temperatures.

The heating part can be affixed onto the mounting part by a mechanical method such as with screws and the like. The support part which supports the mounting part and heating part can be constructed as a ring-shaped support element, or it can be constructed as a plurality of support elements. In addition, the support part can be a combination of a ring-shaped support element and rod-shaped or cylindrical support elements.

The thermal conductivity of the material for the support element which constructs the support part is preferably 50 W/mK or less. When the thermal conductivity exceeds 50 W/mK, the temperature at the contact portion of the mounting part or heating part with the support part is reduced, and the temperature uniformity of the workpiece mounting surface becomes uneven. Preferably, the material for the support part is selected from alumina, mullite, a composite body of mullite and alumina, cordierite, steatite, and forsterite. The Young's modulus for these materials are all 100 GPa or greater. These are preferred because even if a large pressure is applied to the mounting part, they do not readily become deformed.

In addition, if there is a cooling module that can contact or separate from the heating part, the temperature of the workpiece mounting surface can be cooled rapidly. If rapid cooling can be conducted, the processing time can be shorted. In addition, the workpiece does not have to be heated more than is necessary. By having the cooling module movable so that during heating the cooling module is separated from the heating part and during cooling the cooling module is adjacent to the heating part, the electric power during heating can be kept low.

The form for the cooling module is not limited as long as it can contact or separate from the heating part. For example, it can be constructed from a block of a metal or ceramic or a composite body of these. In addition, if a channel for a cooling medium is formed in this block and there is flow of cooling medium, efficient cooling is achieved. There are no particular limitations on the cooling medium. Water is inexpensive and has a large specific heat and is preferred. In addition, the degree of parallelness of the cooling module with respect to the heating part is preferably at 0.5 mm or less at the time of contact. If the degree of parallelness exceeds 0.5 mm, when the cooling module contacts the heating part, there are areas which are in greater contact than other parts. The temperature uniformity of the workpiece mounting surface becomes uneven, and the cooling efficiency is lowered.

When using as a wafer prober or the like, the workpiece mounting surface must have electrical conductivity. In this situation, a conductive layer is preferably formed on the workpiece mounting surface side of the mounting part. The conductive layer is formed by plating or deposition, or coating by sputtering, flame spraying, or screen printing, or the like. However, in order to ensure uniform contact with the workpiece, the surface of the conductive layer is preferably finished with a degree of parallelness of 0.5 mm or less. When the degree of parallelness exceeds 0.5 mm, in order to ensure electrical conduction, the workpiece must be deformed more than is possible, and in some situations, the workpiece can become damaged.

The main component of the conductive layer is preferably Ni. When heated in the atmosphere, Ni is relatively stable, and there is little reduction in electrical conductance. It is an inexpensive material. With Ni, the various methods for forming the conductive layer as described above can be used, but from a cost standpoint, plating is inexpensive and is preferred.

The heating device of the present invention is suitably used for heating and testing a workpiece such as a wafer or the like. For example, when used for a wafer prober, handler, or tester, the high rigidity and high thermal conductivity are particularly advantageous.

### Embodiment 1

For the mounting part, the materials shown in Table 2 were prepared. Table 2 also shows the Young's modulus and thermal conductivity for each material. Each material was machined so that it had a diameter of 330 mm, thickness of 15 mm, degree of parallelness of 0.1 mm or less. Afterwards, Ni was plated onto the workpiece mounting surface at a thickness of 10 micrometers, and the mounting part was completed.

TABLE 2

| | | Young's modulus | Thermal conductivity |
|---|---|---|---|
| No | Material | (GPa) | (W/mK) |
| 1 | Al—SiC | 265 | 170 |
| 2 | Si—SiC | 370 | 220 |
| 3 | SiC | 420 | 60 |
| 4 | AlN | 330 | 170 |
| 5 | Si₃N₄ | 290 | 50 |
| 6 | Al₂O₃ | 380 | 30 |
| 7 | Cu | 130 | 390 |
| 8 | Al | 70 | 230 |

For the heating part, as shown in FIG. 3, a resistance heating element 4, which was made of stainless steel with a thickness of 50 micrometers and with a pattern formation by etching, was interposed between mica 6. This was affixed to the mounting part by screws (not shown).

For the support part, a mullite alumina composite body of outer diameter 330 mm, inner diameter 320 mm, and length 100 mm was prepared. As shown in FIG. 3, the mounting part 1, heating part 2, and support part 3 were assembled, and the heating device was completed. The Young's modulus for the mullite alumina composite body was 320 GPa.

A Si wafer of diameter 300 mm with a circuit formation was mounted onto the workpiece mounting surface of each of the heating devices. A probe card was pushed against the wafer, and the heating device was heated to 200 degrees C. Repeated testing was conducted. As a result, with the heating device in which the mounting part material was Al, when the probe card was pressed 5 times, the mounting part was clearly deformed, and afterwards the wafer was damaged.

In addition, with each of the heating devices, the temperature uniformity of the workpiece mounting surface was measured using a wafer thermometer. The results showed that with the heating device in which the mounting part was of Al₂O₃ material, the temperature uniformity exceeded 200 degrees C±1 degrees C., but with all the other heating devices, it was within ±1 degree C.

### Embodiment 2

Except for changing the thickness of the mounting part to 10 mm, the heating devices were completed with everything else the same as in Embodiment 1. As in Embodiment 1, testing with the pushing by the probe card was conducted. The results showed that the heating device with a mounting part of Cu was gradually deformed. The seventh time resulted in a damaged wafer. With Al, the wafer was damaged after 1 time.

### Embodiment 3

Except for changing the thickness of the mounting part to 7.5 mm, the heating devices were completed with everything else the same as Embodiment 1. As in Embodiment 1, testing with the pushing by the probe card was conducted. With a maximum repetition of 100 times, the number of repetitions until wafer damage occurred was recorded. If there was no damage to the wafer, the amount of deformation of the workpiece mounting surface after the 100 repetitions was measured. These results are shown in Table 3.

TABLE 3

| | | Number of repetitions | Deformation amount |
|---|---|---|---|
| No | Material | until occurrence of damage | (micrometers) |
| 9 | Al—SiC | — | 37 |
| 10 | Si—SiC | — | <10 |
| 11 | SiC | — | <10 |
| 12 | AlN | — | <10 |
| 13 | Si₃N₄ | — | 18 |
| 14 | Al₂O₃ | — | <10 |
| 15 | Cu | 2 | — |
| 16 | Al | 1 | — |

As can be seen from Table 3, when the mounting part used a material with a Young's modulus exceeding 300 GPa, even when the mounting part was thin, the amount of deformation was extremely small.

### Embodiment 4

For the mounting part, Si—SiC with a diameter of 330 mm and thickness of 15 mm was prepared. On the surface on the opposite side of the workpiece mounting surface of the Si—SiC, an alumina-mullite composite was flame sprayed to form a flame spray film of thickness 50 micrometers. A nichrome heater was installed on the flame spray film which is an insulating layer. Furthermore, mica was pressed down on top of this as in Embodiment 1. By attaching with screws, the heating part was completed. Electrode members were attached to this. In addition, as with Embodiment 1, Ni was plated onto the workpiece mounting surface.

For the support part, materials shown in Table 4 were prepared. These were processed so that they had an outer diameter of 330 mm, inner diameter of 320 mm, and a length of 100 mm. The Young's modulus and thermal conductivity for each material are shown in Table 4. As in FIG. 2, the heating devices were completed by assembling the mounting part 1 of Si—SiC, the heating part 2 which includes nichrome as the resistance heating element 4, mica 5, and a flame spray film (not shown), and the support part 3 of the materials shown in Table 4.

As in Embodiment 1, testing by repeated pressing by the probe card was conducted, and the occurrence or non-occurrence of deformation of the mounting part was studied. The results are shown in Table 4. In Table 4, circle indicates that there was no deformation after a repetition of 1000 times. A triangle indicates that there was no deformation after a repetition of 100 times but there was deformation after 1000 times. An X indicates that there was deformation at a repetition of 100 times. In addition, as with Embodiment 1, the temperature uniformity at 200 degrees C. was measured using a wafer thermometer. These results are shown in Table 4.

TABLE 4

| | | Young's | Thermal | | Temperature |
|---|---|---|---|---|---|
| | | modulus | conductivity | Defor- | uniformity |
| No | Material | (GPa) | (W/mK) | mation | (±degrees C.) |
| 17 | Al₂O₃ | 380 | 30 | ◯ | 0.8 |
| 18 | Mullite | 210 | 5 | ◯ | 0.6 |
| 19 | Mullite | 320 | 1 | ◯ | 0.5 |
| | alumina | | | | |
| | composite | | | | |
| 20 | Cordierite | 140 | 4 | ◯ | 0.6 |
| 21 | Forsterite | 190 | 4 | ◯ | 0.6 |
| 22 | Steatite | 130 | 3 | ◯ | 0.6 |
| 23 | SiC | 420 | 60 | ◯ | 1.4 |
| 24 | Al | 70 | 230 | X | 1.2 |

In addition, a support element having an inner diameter of 324 mm was prepared and assembled as described above. The same evaluations were conducted. In addition, rod-shaped support elements with a diameter of 5 mm and length of 100 mm were prepared. Eight support elements were placed evenly in the outermost perimeter of the heating part. In addition, four support elements were placed evenly in the part which corresponds to the 120 mm diameter. The same evaluations were conducted as described above. The results are shown in Table 5. The circle, triangle, and X are the same as in Table 4.

TABLE 5

| | Inner diameter 324 mm | | Rod-shaped | |
|---|---|---|---|---|
| | | Temperature | | Temperature |
| | | uniformity | | uniformity |
| Material | Deformation | (±degrees C.) | Deformation | (±degrees C.) |
| Al₂O₃ | ◯ | 0.7 | ◯ | 0.5 |
| Mullite | Δ | 0.5 | Δ | 0.4 |
| Mullite | ◯ | 0.4 | ◯ | 0.3 |
| alumina | | | | |
| composite | | | | |
| Cordierite | Δ | 0.5 | X | |
| Forsterite | Δ | 0.5 | X | |
| Steatite | Δ | 0.5 | X | |
| SiC | ◯ | 1.3 | ◯ | 1.2 |
| Al | X | — | X | 1.2 |

As can be seen From Tables 4 and 5, when the Young's modulus of the support element is 100 GPa or greater, it can be used without deformation of the mounting part. However, when the support part is thin or a plurality of rod-shaped supporting elements are used, or in other words, when the support part is weaker, at a Young's modulus of less than 200 GPa, the heating device can not withstand use. If the Young's modulus is 300 GPa or greater, it can withstand use regardless of the size of the support part. In addition, when the thermal conductivity is 50 W/mK or less, the temperature uniformity of the workpiece mounting surface is ±1.0 degrees C. or less.

### Embodiment 5

Two aluminum plates of outer diameter 315 mm and thickness 5 mm were prepared. A channel for cooling water was formed on one plate and was screwed onto the other plate with a O-ring in between, and a water cooling module was created. In addition, an aluminum block of diameter 315 mm and thickness 10 mm with no cooling channel was also prepared to create a cooling module without water cooling. This cooling module was installed at a position of 20 mm below the heating part of each of the heating devices of Embodiment 1, and the cooling rates were measured. For the measurement, a wafer thermometer was mounted onto the workpiece mounting surface. With an average temperature of the wafer thermometer of 200 degrees C., the flow of electricity was stopped, and at the same time, the cooling module was placed in contact with the heating part. The time (seconds) until the average temperature of the wafer thermometer reached 100 degrees C. was measured. In the cooling channel, water controlled to a temperature of 20 degrees C. was passed at 1 L/minute. In addition, the cooling time when there was no cooling block was also measured. These results are shown in Table 6.

TABLE 6

| | | Cooling module | Cooling module | No |
|---|---|---|---|---|
| | | with | with no | cooling |
| No | Material | water cooling | water cooling | module |
| 1 | Al—SiC | 165 | 284 | 562 |
| 2 | Si—SiC | 152 | 273 | 543 |
| 3 | SiC | 173 | 298 | 581 |
| 4 | AlN | 160 | 280 | 557 |
| 5 | Si₃N₄ | 195 | 328 | 602 |
| 6 | Al₂O₃ | 176 | 305 | 590 |
| 7 | Cu | 146 | 253 | 540 |
| 8 | Al | 148 | 249 | 524 |

As can be seen from Table 6, by having a cooling module, the cooling rate is improved. By forming a cooling channel in the cooling module and having a cooling medium, the cooling rate is improved further.

According to the present invention, a heating device which is very rigid with little likelihood of warping and which has a workpiece mounting surface with a high thermal conductivity and improved heat uniformity and which can rapidly cool the chip is achieved. As a result, if the heating device of the present invention is used in a semiconductor testing device such as a wafer prober or handler or tester or the like, contact failure due to deformation or warping of the heating device does not occur. In addition, with this semiconductor testing device, there is excellent heat uniformity over the entire wafer. In addition, the temperature can be raised and lowered in a short amount of time.

1. A heating device, comprising:
a mounting part for mounting a workpiece;
a heating part which is for heating said mounting part and which has a resistance heating element;
a support part which supports said mounting part and said heating part;
Young's modulus for said mounting part and said support part are each 100 GPa or greater.

2. A heating device as described in claim 1, wherein:
said Young's modulus for said mounting part and said support part are each 200 GPa or greater.

3. A heating device as described in claim 1, wherein:
said Young's modulus for said mounting part and said support part are each 300 GPa or greater.

4. A heating device as described in claim 1, wherein:
thermal conductivity of said mounting part is 50 W/mK or greater.

5. A heating device as described in claim 1, wherein:
material for said mounting part is selected from a group consisting of Al—SiC, Si—SiC, SiC, AlN, and Si₃N₄.

6. A heating device as described in claim 1, wherein:
said heating part has a resistance heating element formed on the inside or on the surface of a ceramic.

7. A heating device as described in claim 1, wherein:
said heating part is a resistance heating element formed on a surface on the opposite side as a workpiece mounting surface of said mounting part.

8. A heating device as described in claim 1, wherein:
said heating part is constructed as a heating element interposed between insulating elements.

9. A heating device as described in claim 8, wherein:
said insulating element is a resin.

10. A heating device as described in claim 9, wherein:
a filler is dispersed in said resin.

11. A heating device as described in claim 8, wherein:
said insulating element is mica.

12. A heating device as described in claim 1, wherein:
said resistance heating element is stainless steel or nichrome.

13. A heating device as described in claim 1, wherein:
said support part has a thermal conductivity of 50 W/mK or less.

14. A heating device as described in claim 1, wherein:
material for said support part is selected from the group consisting of alumina, mullite, composite of mullite and alumina, cordierite, steatite, and forsterite.

15. A heating device as described in claim 1, wherein:
said heating device is equipped with a cooling module which can contact or separate from said heating part.

16. A heating device as described in claim 1, wherein:
a conductive layer is formed on a workpiece mounting surface side of said mounting part.

17. A heating device as described in claim 16, wherein:
a main component of said conductive layer is Ni.

18. A heating device as described in claim 1, wherein:
said heating device is used in a device for heating and testing a wafer.
